(19) United States
(12) Patent Application Publication
(10) Pub. No.: US 2019/0108648 A1
(43) Pub. Date: Apr. 11, 2019

(54) PHASE DETECTION AUTO-FOCUS-BASED POSITIONING METHOD AND SYSTEM THEREOF

(71) Applicant: Acer Incorporated, New Taipei City (TW)

(72) Inventors: Yi-Huang Lee, New Taipei City (TW); Shih-Ting Huang, New Taipei City (TW); Yi-Jung Chiu, New Taipei City (TW)

(73) Assignee: Acer Incorporated, New Taipei City (TW)

(21) Appl. No.: 15/823,590

(22) Filed: Nov. 28, 2017

(30) Foreign Application Priority Data
Oct. 11, 2017 (TW) 106134827

(51) Int. Cl. G06T 7/55; H04N 5/33; G06T 7/70; H04N 5/247; H04N 5/232

(52) U.S. Cl. CPC G06T 7/55; H04N 5/33; G06T 7/70; G06T 2207/10048; H04N 5/23212; G06T 2207/10028; H04N 5/247

(57) ABSTRACT

A phase detection auto-focus-based (PDAF-based) positioning method and a system thereof are proposed, where the method is applicable to a positioning system having at least three image sensors and a processing device and includes the following steps. A target scene is detected by the first image sensor to generate first phrase detection data and thereby calculate a first object distance. The target scene is detected by the second image sensor to generate second phrase detection data and thereby calculate a second object distance. The target scene is detected by the third image sensor to generate third phrase detection data and thereby calculate a third object distance. Next, a positioning coordinate of the target point is obtained by the processing device according to the first object distance, the second object distance, and the third object distance.

### CROSS-REFERENCE TO RELATED APPLICATION

This application claims the priority benefit of Taiwan application serial no. 106134827, filed on Oct. 11, 2017. The entirety of the above-mentioned patent application is hereby incorporated by reference herein and made a part of this specification.

### TECHNICAL FIELD

The disclosure relates to a positioning method and a system thereof, in particular to, a phase detection auto-focus-based (PDAF-based) positioning method and a system thereof.

### BACKGROUND

The conventional approach for outside-in tracking is to utilize three or more linear image sensors along with their respective cylindrical lenses to obtain a position of a target point through a trigonometry algorithm. Hence, the conventional approach would require high-cost hardware implementation for precise positioning.

### SUMMARY OF THE DISCLOSURE

A PDAF-based positioning method and a system thereof are proposed, where an accurate and effective positioning solution is provided with reduced hardware manufacturing cost.

According to one of the exemplary embodiments, the method is applicable to a positioning system having at least three image sensors and a processing device, where the image sensors include a first image sensor, a second image sensor, and a third image sensor disposed noncollinearly and respectively connected to the processing device. The method includes the following steps. A target scene is detected by the first image sensor to generate first phrase detection data and thereby calculate a first object distance between a target point in the target scene and the first image sensor. The target scene is detected by the second image sensor to generate second phrase detection data and thereby calculate a second object distance between the target point and the second image sensor. The target scene is detected by the third image sensor to generate third phrase detection data and thereby calculate a third object distance between the target point and the third image sensor. A positioning coordinate of the target point is obtained by the processing device according to the first object distance, the second object distance, and the third object distance.

According to one of the exemplary embodiments, the system includes at least third image sensors and a processing device. The image sensors include a first image sensor, a second image sensor, and a third image sensor disposed noncollinearly. The first image sensor is configured to detect a target scene to generate first phrase detection data and calculate a first object distance between a target point in the target scene and the first image sensor according to the first phrase detection data. The second image sensor is configured to detect the target scene to generate second phrase detection data and calculate a second object distance between the target point and the second image sensor according to the second phrase detection data. The third image sensor is configured to detect the target scene to generate third phrase detection data and calculate a third object distance between the target point and the third image sensor according to the third phrase detection data. The processing device is connected to each of the image sensors and configured to obtain a positioning coordinate of the target point according to the first object distance, the second object distance, and the third object distance.

In order to make the aforementioned features and advantages of the present disclosure comprehensible, preferred embodiments accompanied with figures are described in detail below. It is to be understood that both the foregoing general description and the following detailed description are exemplary, and are intended to provide further explanation of the disclosure as claimed.

It should be understood, however, that this summary may not contain all of the aspect and embodiments of the present disclosure and is therefore not meant to be limiting or restrictive in any manner. Also the present disclosure would include improvements and modifications which are obvious to one skilled in the art.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 illustrates a block diagram of a positioning system in accordance with one of the exemplary embodiments of the disclosure.

FIG. 2 illustrates a flowchart of a positioning method in accordance with one of the exemplary embodiments of the disclosure.

FIG. 3 illustrates a scenario diagram of a positioning method in accordance with one of the exemplary embodiments of the disclosure.

To make the above features and advantages of the application more comprehensible, several embodiments accompanied with drawings are described in detail as follows.

### DESCRIPTION OF THE EMBODIMENTS

Some embodiments of the disclosure will now be described more fully hereinafter with reference to the accompanying drawings, in which some, but not all embodiments of the application are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

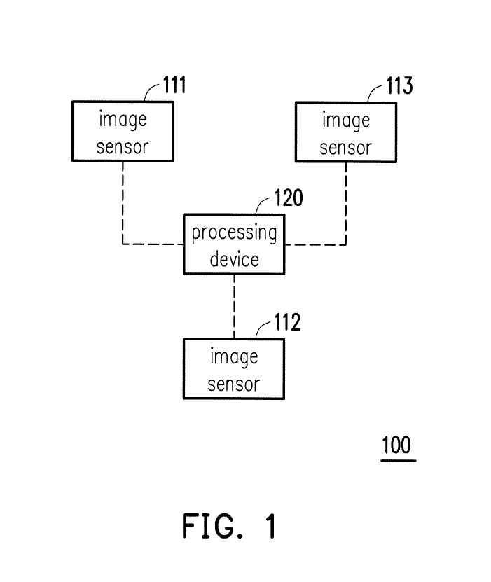

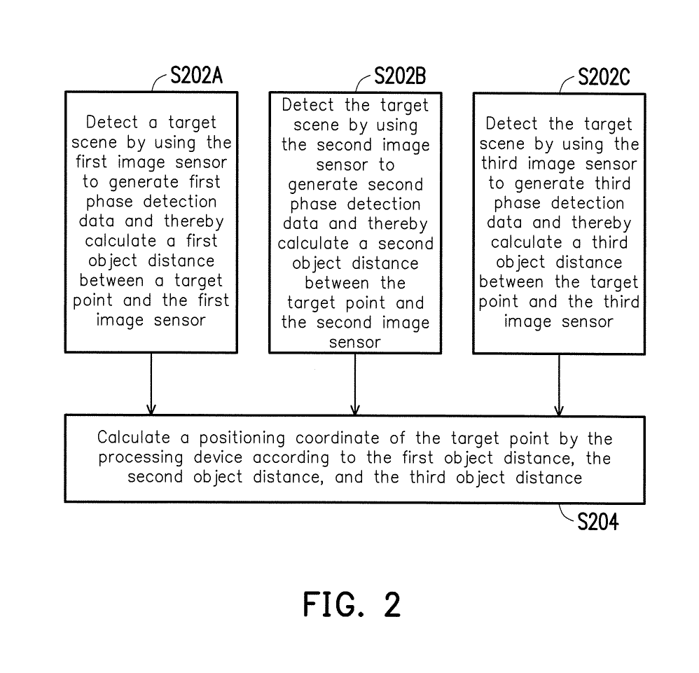

FIG. 1 illustrates a block diagram of a positioning system in accordance with one of the exemplary embodiments of the disclosure. All components of the positioning system and their configurations are first introduced in FIG. 1. The functionalities of the components are disclosed in more detail in conjunction with FIG. 2.

Referring to FIG. 1, a positioning system 100 would include three image sensors 111-113 with a PDAF feature and a processing device 120, where the processing device 120 may be wired or wirelessly connected to the image sensors 111-113.

Each of the image sensors 111-113 would include sensing elements arranged to multiple pairs of phrase detection pixels that are partially-shielded (right-shielded or left-shielded) for phase detection. An offset between each of the left-shielded pixels and its corresponding right-shielded pixel is referred to as “a phase difference”, where the phase difference is associated with the distance between a target object and each image sensor (i.e. an object distance) as known by those skilled in the art. It should be noted that, PDAF features provided in those image sensors available in the market are mostly used along with voice coil motors (VCM) for zooming proposes. However, no auto-focusing process is required in the positioning system 100, and thus the lenses of the image sensors 111-113 may be prime wide-angle lenses for image capturing in order to reduce the costs. In another exemplary embodiment, the image sensors 111-113 may use infrared sensing elements to detect an infrared light source instead of a conventional image capturing mechanism for RGB visible light so that the detection precision of the shielded pixels would not be affected by insufficient amount of admitted light in a dark ambient condition.

The processing device 120 may be a computing device including a processor with computing capabilities, such as a file server, a database server, an application server, a work station, a personal computer. The processor may be for example, a north bridge, a south bridge, a field programmable gate array (FPGA), a programmable logic device (PLD), an application specific integrated circuit (ASIC), other similar or a combination of aforementioned devices. The processor may also be a central processing circuit (CPU), an application processor (AP), or other programmable devices for general purpose or special purpose such as a microprocessor, a digital signal processor (DSP), a graphical processor (GPU), a programmable controller, other similar or a combination of aforementioned devices. It should be understood that the processing device 120 would also include a data storage device. The data storage device may be any form of non-transitory, volatile, and non-volatile memories and configured to store buffered data, permanent data, or compiled programming codes to execute functions of the processing device 120.

FIG. 2 illustrates a positioning method in accordance with one of the exemplary embodiments of the disclosure. The steps of FIG. 2 could be implemented by the positioning system 100 as illustrated in FIG. 1.

Referring to both FIG. 1 and FIG. 2, the first image sensor 111 would detect a target scene to generate first phrase detection data to generate first phrase detection data and thereby calculate a first object distance between a target point in the target scene and the first image sensor 111 (Step S202A), and the second image sensor 112 would detect the target scene to generate second phrase detection data and thereby calculate a second object distance between the target point in the target scene and the second image sensor 112 (Step S202B), and the third image sensor 113 would detect the target scene to generate third phrase detection data and thereby calculate a third object distance between the target point in the target scene and the third image sensor 113 (Step S202C). In other words, after the first image sensor 111, the second image sensor 112, and the third image sensor 113 detect the target scene, each of which would calculate a relative distance between the target point in the target scene and itself, i.e. the first object distance, the second object distance, and the third object distance.

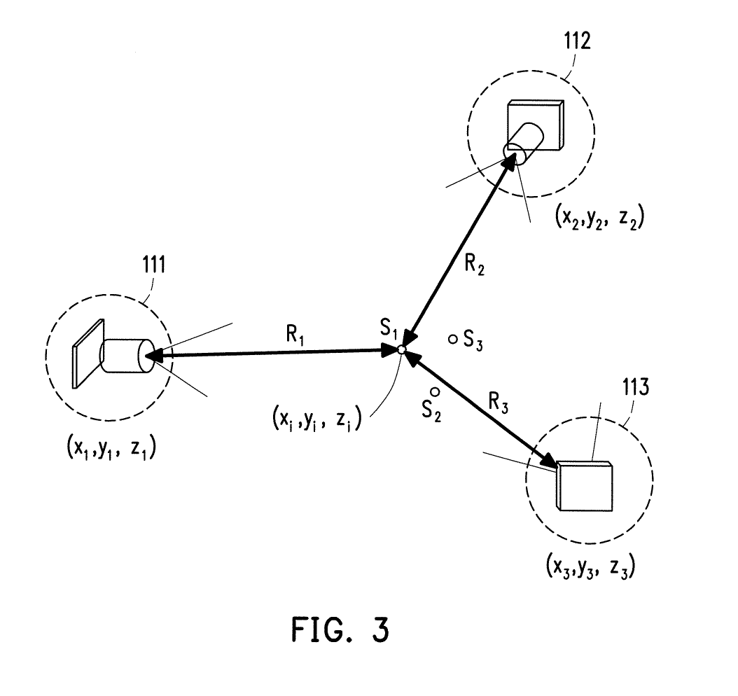

Next, the processing device 120 would obtain a positioning coordinate of the target point according to the first object distance, the second object distance, and the third object distance (Step S204). Herein, the processing device 120 would obtain known spatial coordinates of the first image sensor 111, the second image sensor 112, and the third image sensor 113 (referred to as “a first image sensor coordinate”, “a second image sensor coordinate”, and “a third image sensor coordinate” respectively) and then calculate the positioning coordinate of the target point according to first image sensor coordinate, the second image sensor coordinate, and the third image sensor coordinate as well as the first object distance, the second object distance, and the third object distance. An approach to calculate the positioning coordinate of the target point would be illustrated by a scenario diagram of a positioning method in accordance with one of exemplary embodiments of the disclosure in FIG. 3.

Referring to FIG. 3, assume that S₁ is the target point, R₁ is the first distance between the target point S₁ and the first image sensor 111, R₂ is the second distance between the target point S₁ and the second image sensor 112, and R₃ is the third distance between the target point S₁ and the third image sensor 113. Assume that (xᵢ, yᵢ, zᵢ) is the positioning coordinate of the target point S₁ to be calculated, (x₁, y₁, z₁) is the known first image sensor coordinate, (x₂, y₂, z₂) is the known second image sensor coordinate, and (x₃, y₃, z₃) is the known third image sensor coordinate. Hence, a relationship between the target point S₁ with respect to each of the image sensors 111-113 may be expressed as follows,

(xᵢ−x₁)²+(yᵢ−y₁)²+(zᵢ−z₁)²=R₁²

(xᵢ−x₂)²+(yᵢ−y₂)²+(zᵢ−z₂)²=R₂²

(xᵢ−x₃)²+(yᵢ−y₃)²+(zᵢ−z₃)²=R₃².

After the above expressions are expanded and transposed, Equations (1)-(3) would be obtained,

xᵢ²+yᵢ²+zᵢ²−2x₁xᵢ−2y₁yᵢ−2z₁zᵢ=R₁²−(x₁²+y₁²+z₁²)=A (1)

xᵢ²+yᵢ²+zᵢ²−2x₂xᵢ−2y₂yᵢ−2z₂zᵢ=R₂²−(x₂²+y₂²+z₂²)=B (2)

xᵢ²+yᵢ²+zᵢ²−2x₃xᵢ−2y₃yᵢ−2z₃zᵢ=R₃²−(x₃²+y₃²+z₃²)=C (3)

Next, after the elimination law is applied on Equations (1)-(3), the following expression would be obtained,

2(x₂−x₁)xᵢ+2(y₂−y₁)yᵢ+2(z₂−z₁)zᵢ=A−B (1)-(2)

2(x₃−x₁)xᵢ+2(y₃−y₁)yᵢ+2(z₃−z₁)zᵢ=A−C (1)-(3)

2(x₃−x₂)xᵢ+2(y₃−y₂)yᵢ+2(z₃−z₂)zᵢ=B−C (2)-(3)

The above expression may be written in a matrix form as follows,

$$[ \begin{matrix}2 ( {x}_{2} - {x}_{1} ) & 2 ( {y}_{2} - {y}_{1} ) & 2 ( {z}_{2} - {z}_{1} ) \\ 2 ( {x}_{3} - {x}_{1} ) & 2 ( {y}_{3} - {y}_{1} ) & 2 ( {z}_{3} - {z}_{1} ) \\ 2 ( {x}_{3} - {x}_{2} ) & 2 ( {y}_{3} - {y}_{2} ) & 2 ( {z}_{3} - {z}_{2} )\end{matrix} ] [ \begin{matrix}{x}_{i} \\ {y}_{i} \\ {z}_{i}\end{matrix} ] = [ \begin{matrix}A - B \\ A - C \\ B - C\end{matrix} ] .$$

Hence, the processing device 120 would determine the positioning coordinate γ of the target point according to the following expression,

γ=K⁻¹S

where

$$γ = [ \begin{matrix}{x}_{i} \\ {y}_{i} \\ {z}_{i}\end{matrix} ] K = [ \begin{matrix}2 ( {x}_{2} - {x}_{1} ) & 2 ( {y}_{2} - {y}_{1} ) & 2 ( {z}_{2} - {z}_{1} ) \\ 2 ( {x}_{3} - {x}_{1} ) & 2 ( {y}_{3} - {y}_{1} ) & 2 ( {z}_{3} - {z}_{1} ) \\ 2 ( {x}_{3} - {x}_{2} ) & 2 ( {y}_{3} - {y}_{2} ) & 2 ( {z}_{3} - {z}_{2} )\end{matrix} ] S = [ \begin{matrix}A - B \\ A - C \\ B - C\end{matrix} ]$$

and

A=R₁²−(x₁²+y₁²+z₁²)

B=R₂²−(x₂²+y₂²+z₂²)

C=R₃²−(x₃²+y₃²+z₃²).

It should be noted that, the processing device 120 may obtain a positioning coordinate of a second target point S₂ and a positioning coordinate of a third target point S₃ in the target scene by the processing device, where the target point S₁, the second target point S₂, and the third target point S₃ satisfy the following expression,

\vec{S₃S₁}+\vec{S₁S₂}+\vec{S₂S₃}=0.

In view of the aforementioned descriptions, the proposed positioning method and system in the disclosure determine a spatial coordinate of a target point according to object distances of the target point with respect to at least three image sensors in a PDAF approach. The disclosure provides an accurate and effective positioning solution with reduced hardware manufacturing cost.

No element, act, or instruction used in the detailed description of disclosed embodiments of the present application should be construed as absolutely critical or essential to the present disclosure unless explicitly described as such. Also, as used herein, each of the indefinite articles “a” and “an” could include more than one item. If only one item is intended, the terms “a single” or similar languages would be used. Furthermore, the terms “any of” followed by a listing of a plurality of items and/or a plurality of categories of items, as used herein, are intended to include “any of”, “any combination of”, “any multiple of”, and/or “any combination of multiples of the items and/or the categories of items, individually or in conjunction with other items and/or other categories of items. Further, as used herein, the term “set” is intended to include any number of items, including zero. Further, as used herein, the term “number” is intended to include any number, including zero.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A phase detection auto-focus-based (PDAF-based) positioning method, applicable to a positioning system having at least three image sensors and a processing device, wherein the image sensors comprise a first image sensor, a second image sensor, and a third image sensor disposed noncollinearly and respectively connected to the processing device, and wherein the method comprises the following steps:
detecting a target scene by the first image sensor to generate first phrase detection data and calculate a first object distance between a target point in the target scene and the first image sensor according to the first phrase detection data;
detecting the target scene by the second image sensor to generate second phrase detection data and calculate a second object distance between the target point and the second image sensor according to the second phrase detection data;
detecting the target scene by the third image sensor to generate third phrase detection data and calculate a third object distance between the target point and the third image sensor according to the third phrase detection data; and
obtaining a positioning coordinate of the target point according to the first object distance, the second object distance, and the third object distance by the processing device.

2. The method according to claim 1, wherein the step of obtaining the positioning coordinate of the target point according to the first object distance, the second object distance, and the third object distance comprises:
obtaining a first image sensor coordinate, a second image sensor coordinate, and a third image sensor coordinate, wherein the first image sensor coordinate, the second image sensor coordinate, and the third image sensor coordinate are a spatial coordinate of the first image sensor, a spatial coordinate of the second image sensor, and a spatial coordinate of the third image sensor respectively; and
calculating the positioning coordinate of the target point according to the first image sensor coordinate, the second image sensor coordinate, the third image sensor coordinate, the first object distance, the second object distance, and the third object distance.

3. The method according to claim 2, wherein a formula to calculate the positioning coordinate of the target point is expressed as follows,
γ=K⁻¹S
wherein
$$γ = [ \begin{matrix}{x}_{i} \\ {y}_{i} \\ {z}_{i}\end{matrix} ] K = [ \begin{matrix}2 ( {x}_{2} - {x}_{1} ) & 2 ( {y}_{2} - {y}_{1} ) & 2 ( {z}_{2} - {z}_{1} ) \\ 2 ( {x}_{3} - {x}_{1} ) & 2 ( {y}_{3} - {y}_{1} ) & 2 ( {z}_{3} - {z}_{1} ) \\ 2 ( {x}_{3} - {x}_{2} ) & 2 ( {y}_{3} - {y}_{2} ) & 2 ( {z}_{3} - {z}_{2} )\end{matrix} ] S = [ \begin{matrix}A - B \\ A - C \\ B - C\end{matrix} ]$$
and
A=R₁²−(x₁²+y₁²+z₁²)
B=R₂²−(x₂²+y₂²+z₂²)
C=R₃²−(x₃²+y₃²+z₃²)
wherein γ denotes the positioning coordinate of the target point, (x₁, y₁, z₁) denotes the first image sensor coordinate, (x₂, y₂, z₂) denotes the second image sensor coordinate, (x₃, y₃, z₃) denotes the third image sensor coordinate, R₁ denotes the first object distance, R₂ denotes the second object distance, and R₃ denotes the third object distance.

4. The method according to claim 2 further comprising:
obtaining a positioning coordinate of a second target point and a positioning coordinate of a third target point in the target scene by the processing device, wherein the target point, the second target point, and the third target point satisfy the following expression,
\vec{S₃S₁}+\vec{S₁S₂}+\vec{S₂S₃}=0
wherein S₁ denotes the target point, S₂ denotes the second target point, and S₃ denotes the third target point.

5. A phase detection auto-focus-based (PDAF-based) positioning system comprising:
at least third image sensors, wherein the image sensors comprise a first image sensor, a second image sensor, and a third image sensor disposed noncollinearly and respectively connected to the processing device, and wherein:
the first image sensor is configured to detect a target scene to generate first phrase detection data and calculate a first object distance between a target point in the target scene and the first image sensor according to the first phrase detection data;
the second image sensor is configured to detect the target scene to generate second phrase detection data and calculate a second object distance between the target point and the second image sensor according to the second phrase detection data; and
the third image sensor is configured to detect the target scene to generate third phrase detection data and calculate a third object distance between the target point and the third image sensor according to the third phrase detection data; and
a processing device, connected to each of the image sensors, and configured to obtain a positioning coordinate of the target point according to the first object distance, the second object distance, and the third object distance.

6. The system according to claim 5, wherein the processing device obtains a first image sensor coordinate, a second image sensor coordinate, and a third image sensor coordinate and calculates the positioning coordinate of the target point according to the first image sensor coordinate, the second image sensor coordinate, the third image sensor coordinate, the first object distance, the second object distance, and the third object distance, wherein the first image sensor coordinate, the second image sensor coordinate, and the third image sensor coordinate are a spatial coordinate of the first image sensor, a spatial coordinate of the second image sensor, and a spatial coordinate of the third image sensor respectively.

7. The system according to claim 6, wherein a formula used by the processing device to calculate the positioning coordinate of the target point is expressed as follows,
γ=K⁻¹S
wherein
$$γ = [ \begin{matrix}{x}_{i} \\ {y}_{i} \\ {z}_{i}\end{matrix} ] K = [ \begin{matrix}2 ( {x}_{2} - {x}_{1} ) & 2 ( {y}_{2} - {y}_{1} ) & 2 ( {z}_{2} - {z}_{1} ) \\ 2 ( {x}_{3} - {x}_{1} ) & 2 ( {y}_{3} - {y}_{1} ) & 2 ( {z}_{3} - {z}_{1} ) \\ 2 ( {x}_{3} - {x}_{2} ) & 2 ( {y}_{3} - {y}_{2} ) & 2 ( {z}_{3} - {z}_{2} )\end{matrix} ] S = [ \begin{matrix}A - B \\ A - C \\ B - C\end{matrix} ]$$
and
A=R₁²−(x₁²+y₁²+z₁²)
B=R₂²−(x₂²+y₂²+z₂²)
C=R₃²−(x₃²+y₃²+z₃²)
wherein γ denotes the positioning coordinate of the target point, (x₁, y₁, z₁) denotes the first image sensor coordinate, (x₂, y₂, z₂) denotes the second image sensor coordinate, (x₃, y₃, z₃) denotes the third image sensor coordinate, R₁ denotes the first object distance, R₂ denotes the second object distance, and R₃ denotes the third object distance.

8. The system according to claim 6, wherein the processing device further obtains a positioning coordinate of a second target point and a positioning coordinate of a third target point in the target scene, wherein the target point, the second target point, and the third target point satisfy the following expression,
\vec{S₃S₁}+\vec{S₁S₂}+\vec{S₂S₃}=0
wherein S₁ denotes the target point, S₂ denotes the second target point, and S₃ denotes the third target point.

9. The system according to claim 5, wherein each of the image sensors comprises a wide-angle prime lens.

10. The system according to claim 5, wherein each of the image sensors comprises an infrared sensing element, and wherein the target point is an infrared light source.
